(19) United States
(12) Patent Application Publication
(10) Pub. No.: US 2024/0397495 A1
(43) Pub. Date: Nov. 28, 2024

(54) METHOD FOR CONTROLLING A WIRELESS COMMUNICATION CIRCUIT AND WIRELESS COMMUNICATION CIRCUIT

(71) Applicant: Luxshare Precision Industry Company Limited, SHENZHEN (CN)

(72) Inventor: GUANHSIUNG WANG, SHENZHEN (CN)

(73) Assignee: Luxshare Precision Industry Company Limited, SHENZHEN (CN)

(21) Appl. No.: 18/625,480

(22) Filed: Apr. 3, 2024

(30) Foreign Application Priority Data
May 22, 2023 (CN) 202310582303.8

(51) Int. Cl. H04W 72/0453; H04B 17/345

(52) U.S. Cl. CPC H04W 72/0453; H04B 17/345

(57) ABSTRACT

A control method includes a processing module acquiring current channel state information of a current operation channel corresponding to each of at least two communication paths and sending the current channel state information to a co-frequency coexistence confirmation module; the co-frequency coexistence confirmation module confirming channel states of two of current operation channels according to the current channel state information; and in response to the channel states of the two of current operation channels satisfy a first channel state, the processing module executing a channel reallocation operation on the current operation channel corresponding to the each of at least two communication paths to obtain a target operation channel corresponding to the each of at least two communication paths, and channel states of two of target operation channels satisfying a second channel state.

### CROSS-REFERENCE TO RELATED APPLICATION

This application claims priority to Chinese Patent Application No. 202310582303.8 filed May 22, 2023, the disclosure of which is incorporated herein by reference in its entirety.

### TECHNICAL FIELD

The present application relates to the field of wireless communication technologies and, for example, to a method for controlling a wireless communication circuit and a wireless communication circuit.

### BACKGROUND

In many wireless communication systems, there are usually multiple wireless communication circuits operating in the same frequency band. These circuits have different protocols, MAC layers, and specifications. When these circuits in the same frequency band operate at the same time, co-frequency interference is caused, and quality of wireless communication of these circuits is affected by each other. Therefore, how to make these wireless communication circuits operating in the same frequency band operate at the same time and coexist is the mainstream technology of current research.

### SUMMARY

The present application provides a method for controlling a wireless communication circuit and a wireless communication circuit. Thus, on the premise that multiple communication paths of a wireless communication system which operate in the same frequency band work at the same time, co-frequency interference between communication paths is reduced, and communication quality and communication efficiency are ensured. In addition, in the present application, a co-frequency coexistence confirmation module can first confirm that co-frequency interference exists between two channels. A channel allocation operation is performed only in the case where co-frequency interference is known to exist, thereby suppressing co-frequency interference, improving control accuracy of wireless communication, and saving circuit resources for processing the co-frequency interference.

In a first aspect, an embodiment of the present application provides a method for controlling a wireless communication circuit. The method includes a processing module acquiring current channel state information of at least two current operation channels which are in one-to-one correspondence with at least two communication paths and send the current channel state information to a co-frequency coexistence confirmation module, where the at least two communication paths transmit signals operating in a same frequency band and having different communication protocols; the co-frequency coexistence confirmation module confirming channel states of every two of the at least two current operation channels according to the current channel state information; and in response to the channel states of the every two of the at least two current operation channels satisfy a first channel state, the processing module performing a channel reallocation operation on the at least two current operation channels to obtain at least two target operation channels which are in one-to-one correspondence with the at least two communication paths, where channel states of every two of the at least two target operation channels satisfy a second channel state, where the first channel state is used for indicating that co-frequency interference exists between the every two of the at least two current operation channels; and the second channel state is used for indicating that there is no co-frequency interference between every two of the at least two target operation channels.

In some embodiments, the at least two communication paths include a first communication path and a second communication path. The first channel allocation range corresponding to the first communication path includes a first channel interval and a second channel interval. The second channel allocation range corresponding to the second communication path includes a third channel interval and a fourth channel interval. The first channel interval does not overlap with the fourth channel interval. The second channel interval does not overlap with the third channel interval. In the case where the channel states of the every two of the at least two current operation channels satisfy the first channel state, the processing module performs the channel reallocation operation on the at least two current operation channels to obtain the at least two target operation channels which are in one-to-one correspondence with the at least two communication paths, including, in the case where the first communication path maintains communication and a current operation channel corresponding to the first communication path belongs to the first channel interval, the processing module allocating any channel in the first channel interval as a target channel corresponding to the first communication path and allocating any channel in the fourth channel interval as a target operation channel of the second communication path; and in the case where the first communication path maintains communication and a current operation channel corresponding to the first communication path belongs to the second channel interval, the processing module allocating any channel in the second channel interval as a target channel corresponding to the first communication path and allocating any channel in the third channel interval as a target operation channel of the second communication path.

In some embodiments, the at least two communication paths include a first communication path and a second communication path. The first channel allocation range corresponding to the first communication path includes a first channel interval and a second channel interval. The second channel allocation range corresponding to the second communication path includes a third channel interval and a fourth channel interval. The first channel interval does not overlap with the fourth channel interval. The second channel interval does not overlap with the third channel interval. In a case where the channel states of the any two of at least two current operation channels satisfy the first channel state, the processing module performs the channel reallocation operation on the at least two current operation channels to obtain the at least two target operation channels which are in one-to-one correspondence with the at least two communication paths, includes: in a case where the second communication path maintains communication and a current operation channel corresponding to the second communication path belongs to the third channel interval, the processing module allocating any channel in the third channel interval as a target channel corresponding to the second communication path and allocating any channel in the second channel interval as a target operation channel of the first communication path; and in a case where the second communication path maintains communication and a current operation channel corresponding to the second communication path belongs to the fourth channel interval, the processing module allocating any channel in the fourth channel interval as a target channel corresponding to the second communication path and allocating any channel in the first channel interval as a target operation channel of the first communication path.

In some embodiments, the co-frequency coexistence confirmation module includes an analog-to-digital unit and a coexistence determination unit. Before the processing module acquires the current channel state information of the at least two current operation channels which are in one-to-one correspondence with the at least two communication paths, the method includes the analog-to-digital unit detecting whether the at least two communication paths have target input signals at the same time; and if the at least two communication paths have the target input signals at the same time, the analog-to-digital unit outputting a target digital logic level to enable the coexistence determination unit.

The processing module acquires the current channel state information of the at least two current operation channels which are in one-to-one correspondence with the at least two communication paths, including, in response to enabling the coexistence determination unit, the processing module acquiring the current channel state information of the at least two current operation channels which are in one-to-one correspondence with the at least two communication paths.

In some embodiments, the co-frequency coexistence confirmation module includes a coexistence determination unit. After, in response to the channel states of the every two of the at least two current operation channels satisfy the first channel state, the processing module performs the channel reallocation operation on the at least two current operation channels to obtain the at least two target operation channels which are in one-to-one correspondence with the at least two communication paths, the method also includes the coexistence determination unit enabling the at least two communication paths so that every two of the at least two communication paths operate on a respective corresponding target operation channel.

In some embodiments, the processing module acquires the current channel state information of the at least two current operation channels which are in one-to-one correspondence with the at least two communication paths, including, the processing module performing channel estimation on the at least two current operation channels which are in one-to-one correspondence with the at least two communication paths to obtain first channel state information corresponding to each of the at least two communication paths; the co-frequency coexistence confirmation module determining whether history channel state information exists before the first channel state information; and in the case where the history channel state information exists, the co-frequency coexistence confirmation module using the first channel state information as the current channel state information.

In some embodiments, after the co-frequency coexistence confirmation module determines whether the history channel state information exists before the current channel state information, the method also includes,

in a case where there is no history channel state information, the co-frequency coexistence confirmation module sending a channel estimation adjustment signal to the processing module; the processing module performing channel estimation on the at least two current operation channels to obtain second channel state information corresponding to each of the at least two communication paths, where the second channel state information is used for triggering the processing module to reallocate the at least two current operation channels; and the processing module using the second channel state information as the current channel state information.

In some embodiments, the co-frequency coexistence confirmation module confirming the channel states of the every two of the at least two current operation channels according to the current channel state information includes, in the case where the history channel state information exists, the co-frequency coexistence confirmation module comparing the current channel state information with the history channel state information to obtain a state comparison result; if the state comparison result indicates that the first channel state information is consistent with the history channel state information, the co-frequency coexistence confirmation module determining a wireless connection state between the at least two communication paths and a remote electronic apparatus; and in response to the at least two communication paths are in connection state, the co-frequency coexistence confirmation module confirming the channel states of the every two of the at least two current operation channels according to the first channel state information.

In some embodiments, in response to the channel states of the every two of the at least two current operation channels satisfy the first channel state, the processing module performs the channel reallocation operation on the at least two current operation channels to obtain the at least two target operation channels which are in one-to-one correspondence with the at least two communication paths, includes: in response to the channel states of the every two of the at least two current operation channels satisfy the first channel state, the co-frequency coexistence confirmation module sending a channel reallocation adjustment signal to the processing module; and the processing module performing, according to the channel reallocation adjustment signal, the channel reallocation operation on the at least two current operation channels which are in one-to-one correspondence with the at least two communication paths to obtain the at least two target operation channels.

In a second aspect, an embodiment of the present application provides a wireless communication circuit. The wireless communication circuit is configured to execute the method for controlling a wireless communication circuit provided in any one of the preceding embodiments. The wireless communication circuit includes a processing module, a co-frequency coexistence confirmation module, and at least two communication paths, where the at least two communication paths transmit signals operating in a same frequency band and having different communication protocols. The processing module is electrically connected to the co-frequency coexistence confirmation module, the processing module is separately and electrically connected to each of the at least two communication paths, and the processing module is configured to acquire current channel state information of at least two current operation channels which are in one-to-one correspondence with the at least two communication paths and send the current channel state information to the co-frequency coexistence confirmation module. The co-frequency coexistence confirmation module is separately and electrically connected to each of the at least two communication paths, and the co-frequency coexistence confirmation module is configured to confirm channel states of every two of the at least two current operation channels according to the current channel state information; and in response to the channel states of every two of at least two current operation channels satisfy a first channel state, the processing module is configured to perform channel reallocation operation on the at least two current operation channels to obtain at least two target operation channels which are in one-to-one correspondence with the at least two communication paths, and channel states of the every two of the at least two target operation channels satisfy a second channel state, where the first channel state is used for indicating that co-frequency interference exists between the every two of the at least two current operation channels, and the second channel state is used for indicating that there is no co-frequency interference between the at least two target operation channels.

In some embodiments, the co-frequency coexistence confirmation module includes the analog-to-digital unit and the coexistence determination unit. The analog-to-digital unit is electrically connected to the processing module. The analog-to-digital unit includes at least two signal input terminals and a coexistence determination enabling terminal. Signal input terminals are connected to communication paths in a one-to-one manner. The coexistence determination enabling terminal is connected to the coexistence determination unit. The analog-to-digital unit is configured to have a target input signal at each signal input terminal and output a target digital logic level through the coexistence determination enabling terminal to enable the coexistence determination unit. The coexistence determination unit is configured to determine channel states of two of current operation channels according to the current channel state information in the enabling state.

In some embodiments, the coexistence determination unit includes an adjustment signal output terminal and a state information input terminal. The adjustment signal output terminal and the state information input terminal are electrically connected to the processing module. The coexistence determination unit is configured to acquire current channel state information from the processing module through the state information input terminal and determine channel states of two of current operation channels according to the current channel state information. In the case where the channel states of two of current operation channels satisfy the first channel state, the coexistence determination unit sends a channel reallocation adjustment signal to the processing module through the adjustment signal output terminal. The processing module is configured to reallocate a current operation channel of each communication path according to the channel reallocation adjustment signal to obtain a target operation channel corresponding to the each communication path.

### BRIEF DESCRIPTION OF DRAWINGS

To illustrate technical solutions in embodiments of the present application more clearly, the drawings used in description of the embodiments are briefly described below. Apparently, the drawings described below merely illustrate part of embodiments of the present application, and those skilled in the art may obtain other drawings based on the drawings described below on the premise that no creative work is done.

FIG. 1 is a flowchart of a method for controlling a wireless communication circuit according to an embodiment of the present application.

FIG. 2 is a flowchart of another method for controlling a wireless communication circuit according to an embodiment of the present application.

FIG. 3 is a flowchart of another method for controlling a wireless communication circuit according to an embodiment of the present application.

FIG. 4 is a flowchart of another method for controlling a wireless communication circuit according to an embodiment of the present application.

FIG. 5 is a flowchart of another method for controlling a wireless communication circuit according to an embodiment of the present application.

FIG. 6 is a flowchart of another method for controlling a wireless communication circuit according to an embodiment of the present application.

FIG. 7 is a flowchart of another method for controlling a wireless communication circuit according to an embodiment of the present application.

FIG. 8 is a diagram illustrating the structure of a wireless communication circuit according to an embodiment of the present application.

FIG. 9 is a diagram illustrating the structure of another wireless communication circuit according to an embodiment of the present application.

### DETAILED DESCRIPTION

For a better understanding of the technical solutions by those skilled in the art, the technical solutions in embodiments of the present application are described clearly and completely in conjunction with the drawings in embodiments of the present application. Apparently, the embodiments described below are part, not all, of the embodiments of the present application. Based on the embodiments described herein, all other embodiments obtained by those skilled in the art on the premise that no creative work is done are within the scope of the present application.

It is to be noted that the terms “first”, “second”, and the like in the description, claims, and drawings of the present application are used for distinguishing between similar objects and are not necessarily used for describing a particular order or sequence. It is to be understood that the data used in this way is interchangeable where appropriate so that the embodiments of the present application described herein may also be implemented in a sequence not illustrated or described herein. In addition, the terms “including”, “having”, or any other variations thereof described herein are intended to encompass a non-exclusive inclusion. For example, a process, method, system, product, or device that includes a series of steps or units may include not only the expressly listed steps or units but also other steps or units that are not expressly listed or are inherent to such a process, method, system, product, or device.

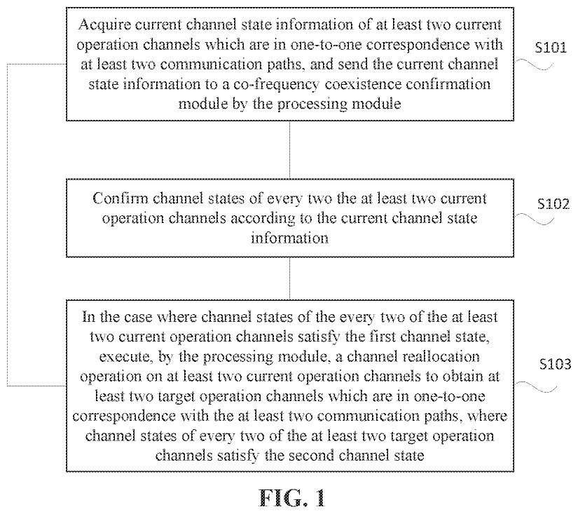

FIG. 1 is a flowchart of a method for controlling a wireless communication circuit according to an embodiment of the present application. As shown in FIG. 1, the method for controlling a wireless communication circuit includes the following steps.

In S101, a processing module acquires current channel state information of at least two current operation channels which are in one-to-one correspondence with at least two communication paths and sends the current channel state information to a co-frequency coexistence confirmation module.

The processing module can perform channel estimation on the at least two current operation channels to obtain the current channel state information corresponding to each of the at least two communication paths.

The at least two communication paths transmit signals operating in the same frequency band and having different communication protocols. The communication protocols of the communication paths include a ZigBee RF4CE communication protocol, a wireless local area network communication protocol, and a Bluetooth communication protocol, or MAC layer protocols specified by different wireless local area networks. Exemplarily, the processing module can handle co-frequency interference existing in 4G or 5G.

In some embodiments, the processing module has a channel estimation mechanism to obtain current channel state information and channel connection quality of each communication path. The processing module may include a single-chip microcomputer, and may also include a digital signal processor (DSP) and a field programmable gate array (FPGA).

A channel is also referred to as an information channel. A frequency band refers to a certain frequency range of a radio wave. Each frequency band is divided into multiple information channels. A wireless local area network (for example, router, AP hotspot, and computer wireless network card) can operate on multiple channels. Each channel occupies a certain frequency range. Exemplarily, a 2.4 G wireless local area network, whose frequency band is between 2.405 GHz to 2.485 GHz, is generally divided into 13 channels in European standard. The bandwidth of each channel is 20 MHz in HT20 mode.

Channel state information (CSI) is a channel attribute of a communication link. The CSI describes the attenuation factor of a signal on each transmission path, as well as the operation channel and operation frequency of a signal on each transmission path. That is, values of each element in a channel gain matrix H including information such as signal scattering, environmental fading (multipath fading, shadowing fading, Rayleigh fading, or Rician fading), and power decay of distance. The CSI can make a communication system adapt to current wireless channel conditions, providing a guarantee for high-reliability and high-rate communication in a multi-antenna system. Exemplarily, the current channel state information in the wireless communication may include channel quality, multipath delay, Doppler frequency offset, rank of a Multiple-Input Multiple-Output (MIMO) channel, and a beamforming vector, and may also include the operation channel and operation frequency of a signal on each transmission path.

In S102, the co-frequency coexistence confirmation module confirms channel states of every two the at least two current operation channels according to the current channel state information.

In this embodiment, the co-frequency coexistence confirmation module only receives signals from ports transmitted from the processing module to each communication path, and does not output any signals to participate in the actual signal transmission of the communication path, nor radiates signals to a remote electronic apparatus.

Channel states of current operation channels include a first channel state and a second channel state. The first channel state is used for indicating that co-frequency interference exists between every two of the at least two current operation channels. The second channel state is used for indicating that there is no co-frequency interference between every two of the at least two target operation channels. The co-frequency coexistence confirmation module determining the channel states of every two of the at least two current operation channels according to the current channel state information means that the co-frequency coexistence confirmation module determines whether co-frequency interference exists between every two of the at least two current operation channels according to the current channel state information.

In S103, in the case where channel states of the every two of the at least two current operation channels satisfy the first channel state, the processing module executes a channel reallocation operation on the at least two current operation channels to obtain at least two target operation channels which are in one-to-one correspondence with the at least two communication paths. Channel states of every two of the at least two target operation channels satisfy the second channel state.

In some embodiments, the co-frequency coexistence confirmation module includes an adjustment signal output terminal. In the case where channel states of every two of the at least two current operation channels satisfy the first channel state, the co-frequency coexistence confirmation module can send a channel reallocation adjustment signal to the processing module through the adjustment signal output terminal. The processing module executes the channel reallocation operation on the current operation channel corresponding to the each of at least two communication paths according to the channel reallocation adjustment signal to obtain the target operation channel corresponding to the each communication path.

A current operation channel corresponding to a communication path in a connected state of at least two current operation channels is used as a first operation channel. A current operation channel corresponding to a communication path in an unconnected state of the at least two current operation channels is used as a second operation channel. Target operation channels include a first target channel and a second target channel. The first operation channel corresponds to the first target channel. The second operation channel corresponds to the second target channel.

In some embodiments, in the case where channel states of every two of the at least two current operation channels satisfy the first channel state, that is, the communication path in the connected state is still in the wireless connection state, and the communication path in the unconnected state is already in the wireless connection state at this time, the channel reallocation operation can be an operation of executing channel reallocation on both the first operation channel and the second operation channel. The processing module executes channel reallocation on both the first operation channel and the second operation channel to obtain the first target channel and the second target channel. Channel states of the first target channel and the second target channel satisfy the second channel state.

In some embodiments, in the case where channel states of every two of the at least two current operation channels satisfy the first channel state, when the processing module executes channel reallocation on the first operation channel, the original first operation channel is used as the first target channel. This means that the channel reallocation operation is not executed on the first operation channel. The channel reallocation is executed only on the second operation channel to obtain the second target channel. Channel states of the second target channel and the first operation channel satisfy the second channel state. Exemplarily, the operation of performing channel reallocation on the second operation channel may be comparing channel state information of the second operation channel with channel state information of operation channels excluding the second operation channel in the same interval. A channel whose communication quality corresponding to channel state information is greater than the communication quality corresponding to the channel state information of the second operation channel is selected as the second target channel. The communication quality corresponds to the channel state information. That is, the communication quality is related to the channel gain, the signal attenuation, and the like. The communication quality is higher when the channel gain is larger. The communication quality is higher when the signal attenuation is smaller. The communication quality can be measured by collecting at least one piece of channel state information. That is, in this embodiment, the communication can be more stable without switching operation channels of connected communication paths. The processing module reallocates current operation channels of communication paths so that target operation channels of the communication paths do not have co-frequency interference. Then, the starting step in the method for controlling a wireless communication circuit is returned to continue to execute. The starting step in this embodiment is step S101.

According to the method for controlling a wireless communication circuit in this embodiment of the present application, the processing module acquires current channel state information of a current operation channel corresponding to each of at least two communication paths and sends the current channel state information to the co-frequency coexistence confirmation module. The co-frequency coexistence confirmation module confirms channel states of every two of the at least two current operation channels according to the current channel state information. In the case where co-frequency interference between channel states of every two of the at least two current operation channels exists, the processing module executes a channel reallocation operation on the current operation channel corresponding to the each of at least two communication paths to obtain a target operation channel corresponding to the each of at least two communication paths. The channel states of every two of the at least two target operation channels do not have co-frequency interference. Thus, on the premise that multiple communication paths of a wireless communication system which operate in the same frequency band work at the same time, co-frequency interference between communication paths is reduced, and communication quality and communication efficiency are ensured. In addition, in the present application, a co-frequency coexistence confirmation module can first confirm that co-frequency interference exists between every two of the at least two channels. A channel allocation operation is performed only in the case where co-frequency interference is known to exist, thereby suppressing co-frequency interference, improving control accuracy of wireless communication, and saving circuit resources for processing the co-frequency interference.

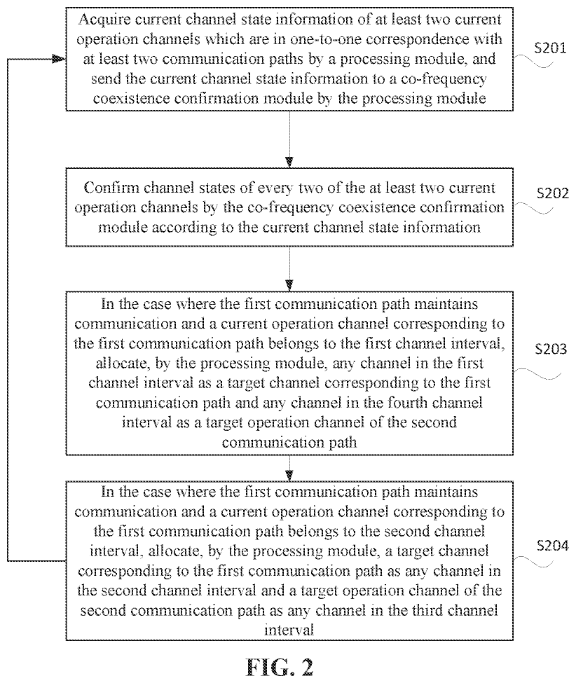

FIG. 2 is a flowchart of another method for controlling a wireless communication circuit according to an embodiment of the present application. Based on the preceding embodiments, the at least two communication paths include a first communication path and a second communication path. The first channel allocation range corresponding to the first communication path includes a first channel interval and a second channel interval. The second channel allocation range corresponding to the second communication path includes a third channel interval and a fourth channel interval. The first channel interval does not overlap with the fourth channel interval. The second channel interval does not overlap with the third channel interval.

As shown in FIG. 2, the method for controlling a wireless communication circuit includes the following steps.

In S201, a processing module acquires current channel state information of at least two current operation channels which are in one-to-one correspondence with at least two communication paths and sends the current channel state information to a co-frequency coexistence confirmation module.

The processing module can perform channel estimation on the at least two current operation channels corresponding to the at least two communication paths to obtain the current channel state information corresponding to each of the at least two communication paths.

In S202, the co-frequency coexistence confirmation module confirms channel states of every two of the at least two current operation channels according to the current channel state information.

In S203, in the case where the first communication path maintains communication and a current operation channel corresponding to the first communication path belongs to the first channel interval, the processing module allocates any channel in the first channel interval as a target channel corresponding to the first communication path and any channel in the fourth channel interval as a target operation channel of the second communication path.

The in-band channel of the first communication path is 1 to N. The in-band channel of the second communication path is 0 to M. N and M are integers. Exemplarily, the first channel interval may be 1˜└N/2┘. The second channel interval may be └N/2┘˜N or ┌N−(N/2)┐˜N. The third channel interval may be 0˜└M/2┘. The fourth channel interval may be ┌M−(M/2)┐˜M or └M/2┘˜M.

In some embodiments, in the case where the first communication path maintains communication and a current operation channel corresponding to the first communication path belongs to the first channel interval, the channel reallocation operation may be executed on both the current operation channel of the first communication path and the current operation channel of the second communication path. The processing module allocates a target channel corresponding to the first communication path as a channel whose communication quality is greater than the communication quality of the current operation channel corresponding to the first communication path in the first channel interval and a target channel corresponding to the second communication path as a channel whose communication quality is greater than the communication quality of the current operation channel corresponding to the second communication path in the fourth channel interval. How to measure the communication quality of an operation channel has been discussed in the preceding embodiments. Details are not described herein.

In the case where the first communication path maintains communication and a current operation channel corresponding to the first communication path belongs to the first channel interval, the processing module may use the current operation channel of the first communication path as a target operation channel. That is, the current operation channel of the first communication path is kept unchanged. The target operation channel of the second communication path is allocated as a channel whose communication quality is greater than the communication quality of the current operation channel corresponding to the second communication path in the fourth channel interval.

In S204, in the case where the first communication path maintains communication and a current operation channel corresponding to the first communication path belongs to the second channel interval, the processing module allocates a target channel corresponding to the first communication path as any channel in the second channel interval and a target operation channel of the second communication path as any channel in the third channel interval.

In some embodiments, in the case where the first communication path maintains communication and a current operation channel corresponding to the first communication path belongs to the second channel interval, the channel reallocation operation may be executed on both the current operation channel of the first communication path and the current operation channel of the second communication path. The processing module allocates a target channel corresponding to the first communication path as a channel whose communication quality is greater than the communication quality of the current operation channel corresponding to the first communication path in the second channel interval and a target channel corresponding to the second communication path as a channel whose communication quality is greater than the communication quality of the current operation channel corresponding to the second communication path in the third channel interval.

In the case where the first communication path maintains communication and a current operation channel corresponding to the first communication path belongs to the second channel interval, the processing module may use the current operation channel of the first communication path as a target operation channel. That is, the current operation channel of the first communication path is kept unchanged. The target operation channel of the second communication path is allocated as a channel whose communication quality is greater than the communication quality of the current operation channel corresponding to the second communication path in the third channel interval.

The processing module reallocates current operation channels of communication paths so that target operation channels of the communication paths do not have co-frequency interference. Then, the starting step in the method for controlling a wireless communication circuit is returned to continue to execute. The starting step in this embodiment is step S201.

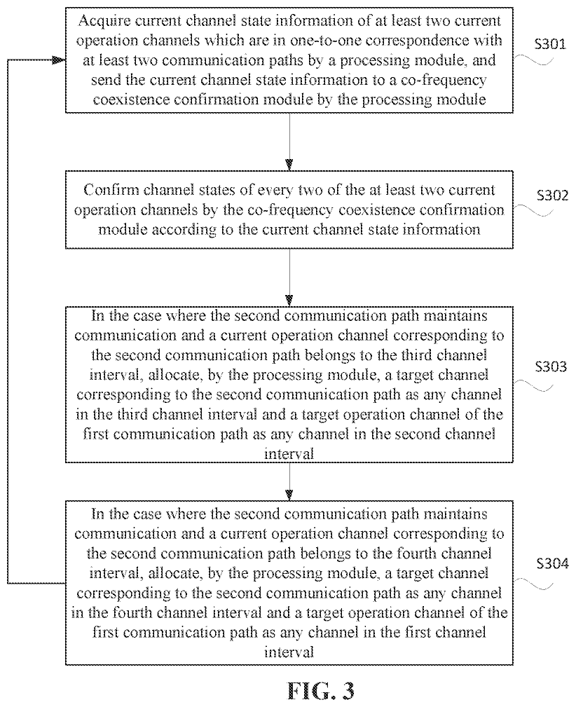

FIG. 3 is a flowchart of another method for controlling a wireless communication circuit according to an embodiment of the present application. Based on the embodiments in FIG. 1, the at least two communication paths include a first communication path and a second communication path. The first channel allocation range corresponding to the first communication path includes a first channel interval and a second channel interval. The second channel allocation range corresponding to the second communication path includes a third channel interval and a fourth channel interval. The first channel interval does not overlap with the fourth channel interval. The second channel interval does not overlap with the third channel interval.

As shown in FIG. 3, the method for controlling a wireless communication circuit may include the following steps.

In S301, a processing module acquires current channel state information of at least two current operation channels which are in one-to-one correspondence with at least two communication paths and sends the current channel state information to a co-frequency coexistence confirmation module.

The processing module can perform channel estimation on the at least two current operation channels corresponding to the at least two communication paths to obtain the current channel state information corresponding to each of the at least two communication paths.

In S302, the co-frequency coexistence confirmation module confirms channel states of every two of the at least two current operation channels according to the current channel state information.

If the channel states of every two of the at least two current operation channels satisfy the first channel state, step S303 and subsequent steps are executed. If the channel states of every two of the at least two current operation channels do not satisfy the first channel state, step S302 is repeatedly executed.

In S303, in the case where the second communication path maintains communication and a current operation channel corresponding to the second communication path belongs to the third channel interval, the processing module allocates a target channel corresponding to the second communication path as any channel in the third channel interval and a target operation channel of the first communication path as any channel in the second channel interval.

The in-band channel of the first communication path is 1 to N. The in-band channel of the second communication path is 0 to M. N and M are integers. Exemplarily, the first channel interval may be 1˜└N/2┘. The second channel interval may be └N/2┘˜N or ┌N−(N/2)┐˜N. The third channel interval may be 0˜└M/2┘. The fourth channel interval may be ┌M−(M/2)┐˜M or └M/2┘˜M.

In some embodiments, in the case where the second communication path maintains communication and a current operation channel corresponding to the second communication path belongs to the third channel interval, the channel reallocation operation may be executed on both the current operation channel of the first communication path and the current operation channel of the second communication path. The processing module allocates a target channel corresponding to the first communication path as a channel whose communication quality is greater than the communication quality of the current operation channel corresponding to the first communication path in the second channel interval and a target channel corresponding to the second communication path as a channel whose communication quality is greater than the communication quality of the current operation channel corresponding to the second communication path in the third channel interval.

In the case where the second communication path maintains communication and a current operation channel corresponding to the first communication path belongs to the third channel interval, the processing module may use the current operation channel of the first communication path as a target operation channel. That is, the current operation channel of the second communication path is kept unchanged. The target operation channel of the first communication path is allocated as a channel whose communication quality is greater than the communication quality of the current operation channel corresponding to the first communication path in the second channel interval.

In S304, in the case where the second communication path maintains communication and a current operation channel corresponding to the second communication path belongs to the fourth channel interval, the processing module allocates a target channel corresponding to the second communication path as any channel in the fourth channel interval and a target operation channel of the first communication path as any channel in the first channel interval.

In some embodiments, in the case where the second communication path maintains communication and a current operation channel corresponding to the second communication path belongs to the fourth channel interval, the channel reallocation operation may be executed on both the current operation channel of the first communication path and the current operation channel of the second communication path. The processing module allocates a target channel corresponding to the first communication path as a channel whose communication quality is greater than the communication quality of the current operation channel corresponding to the first communication path in the first channel interval and a target channel corresponding to the second communication path as a channel whose communication quality is greater than the communication quality of the current operation channel corresponding to the second communication path in the fourth channel interval.

In the case where the second communication path maintains communication and a current operation channel corresponding to the first communication path belongs to the fourth channel interval, the processing module may use the current operation channel of the first communication path as a target operation channel. That is, the current operation channel of the second communication path is kept unchanged. The target operation channel of the first communication path is allocated as a channel whose communication quality is greater than the communication quality of the current operation channel corresponding to the first communication path in the first channel interval.

The processing module reallocates current operation channels of communication paths so that target operation channels of the communication paths do not have co-frequency interference. Then, the starting step in the method for controlling a wireless communication circuit is returned to continue to execute. The starting step in this embodiment is step S301.

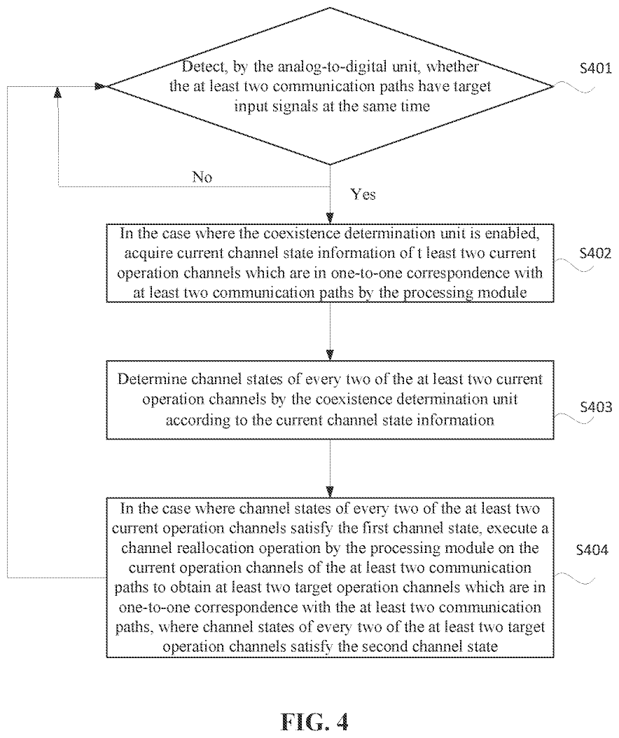

FIG. 4 is a flowchart of another method for controlling a wireless communication circuit according to an embodiment of the present application. Based on the embodiments in FIG. 1, the co-frequency coexistence confirmation module includes an analog-to-digital unit and a coexistence determination unit.

As shown in FIG. 4, before the processing module acquires the current channel state information of the current operation channel corresponding to the each of at least two communication paths and sends the current channel state information to the co-frequency coexistence confirmation module, the method for controlling a wireless communication circuit may include the following steps.

In S401, the analog-to-digital unit detects whether the at least two communication paths have target input signals at the same time.

Each target input signal is a signal having a communication signal. Each non-target input signal is a signal without a communication signal. Exemplarily, the target input signal may be a high-level signal, and the non-target input signal may be a low-level signal. When at least two communication paths simultaneously input a high-level signal to the analog-to-digital unit, the analog-to-digital unit confirms that target input signals exist in the at least two communication paths at the same time. Then, the analog-to-digital unit outputs a target digital logic level to enable the coexistence determination unit. If one communication path transmits a high-level signal to the analog-to-digital unit and another communication path transmits a low-level signal to the analog-to-digital unit, the analog-to-digital unit confirms that the target input signals do not exist in the at least two communication paths at the same time. Step S401 is repeatedly executed. Therefore, if the target input signals exist in the at least two communication paths at the same time, step S402 and subsequent steps are executed. If the target input signals do not exist in the at least two communication paths at the same time, step S401 is repeatedly executed.

The digital logic level may be a TTL level, that is, a transistor-transistor logic level. The target digital logic level is an output TTL level when each target input signal is at a high level and can be equivalent to a result obtained by performing an AND operation between target input signals.

In S402, in the case where the coexistence determination unit is enabled, the processing module acquires current channel state information of at least two current operation channels which are in one-to-one correspondence with at least two communication paths and sends the current channel state information to a co-frequency coexistence confirmation module.

In S403, the coexistence determination unit determines channel states of every two of the at least two current operation channels according to the current channel state information.

In some embodiments, the channel state information of a first communication path is compared with the channel state information of a second communication path to determine whether co-frequency interference exists between the first communication path and the second communication path. If co-frequency interference exists, a first channel state is generated. If co-frequency interference does not exist, a second channel state is generated.

In S404, in the case where channel states of every two of the at least two current operation channels satisfy the first channel state, the processing module executes a channel reallocation operation on the current operation channels of the at least two communication paths to obtain at least two target operation channels which are in one-to-one correspondence with the at least two communication paths. Channel states of every two of the at least two target operation channels satisfy the second channel state.

The processing module reallocates current operation channels of the at least two communication paths so that target operation channels of the communication paths do not have co-frequency interference. Then, the starting step in the method for controlling a wireless communication circuit is returned to continue to execute. The starting step in this embodiment is step S401.

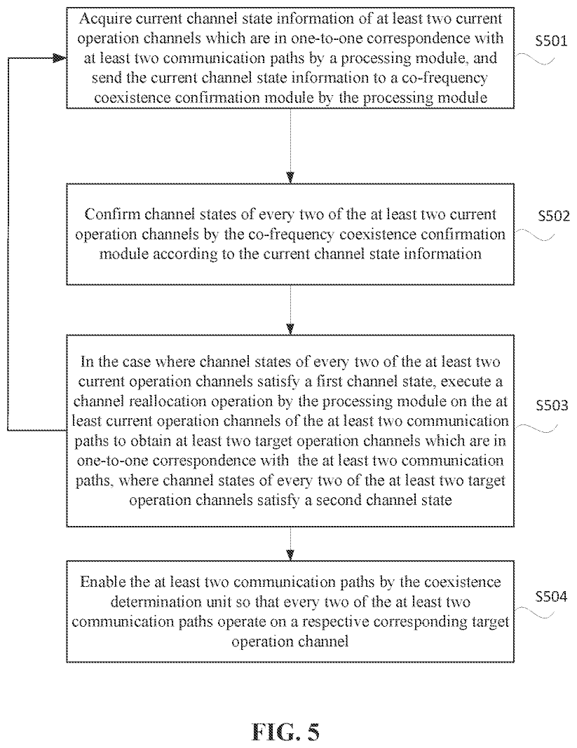

FIG. 5 is a flowchart of another method for controlling a wireless communication circuit according to an embodiment of the present application. Based on the embodiments in FIG. 1, the co-frequency coexistence confirmation module includes a coexistence determination unit. As shown in FIG. 5, the method for controlling a wireless communication circuit may include the following steps.

In S501, a processing module acquires current channel state information of at least two current operation channels which are in one-to-one correspondence with at least two communication paths and sends the current channel state information to a co-frequency coexistence confirmation module.

The processing module can perform channel estimation on the at least two current operation channels corresponding to the at least two communication paths to obtain the current channel state information corresponding to each of the at least two communication paths.

In S502, the co-frequency coexistence confirmation module confirms channel states of every two of the at least two current operation channels according to the current channel state information.

In S503, in the case where channel states of every two of the at least two current operation channels satisfy a first channel state, the processing module executes a channel reallocation operation on the at least current operation channels of the at least two communication paths to obtain at least two target operation channels which are in one-to-one correspondence with the at least two communication paths. Channel states of every two of the at least two target operation channels satisfy a second channel state.

The processing module reallocates current operation channels of communication paths so that target operation channels of the communication paths do not have co-frequency interference. Then, the starting step in the method for controlling a wireless communication circuit is returned to continue to execute. The starting step in this embodiment is step S501.

In S504, the coexistence determination unit enables the at least two communication paths so that every two of the at least two communication paths operate on a respective corresponding target operation channel.

In some embodiments, a communication path includes a first connection terminal and a second connection terminal. The processing module is electrically connected to the first connection terminal of the communication path by the first communication port of the processing module. Each of the at least two communication paths includes a front-end processing unit, a fundamental frequency unit, and a radio frequency front-end unit that are sequentially connected from the first connection terminal to the second connection terminal. The radio frequency front-end unit is configured to up-frequency a fundamental frequency signal or down-frequency a signal received from the outside. The fundamental frequency unit is configured to output a fundamental frequency signal to the front-end processing unit or the radio frequency front-end unit. The front-end processing unit is configured to process the received fundamental frequency signal and then output the processed fundamental frequency signal to the processing module, and/or to process digit information output from the processing module and then output the processed digit information to the fundamental frequency unit. The enable output terminal of the coexistence determination unit is connected to the radio frequency front-end unit. Therefore, after the coexistence determination unit receives a digital logic level and receives current channel state information corresponding to the second channel state, the corresponding communication path is enabled by the coexistence determination unit through the enable output terminal.

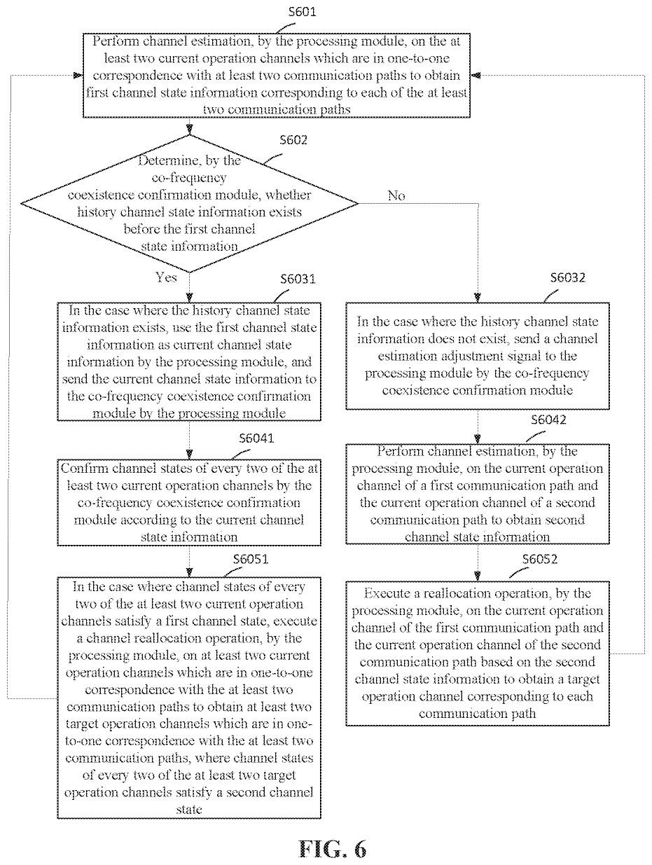

FIG. 6 is a flowchart of another method for controlling a wireless communication circuit according to an embodiment of the present application. Based on the embodiments in FIG. 1, as shown in FIG. 6, the processing module acquires the current channel state information of the current operation channel corresponding to the each of at least two communication paths and sends the current channel state information to the co-frequency coexistence confirmation module, including the following steps.

In S601, the processing module performs channel estimation on the at least two current operation channels which are in one-to-one correspondence with at least two communication paths to obtain first channel state information corresponding to each of the at least two communication paths.

In S602, the co-frequency coexistence confirmation module determines whether history channel state information exists before the first channel state information.

The history channel state information is channel state information obtained by performing channel estimation by the processing module before the first channel state information. In the case where history channel state information exists, it indicates that each communication path does not have signals for the first time. Channel state information corresponding to each communication path is known channel state information. In the case where a target digital logic level output by the co-frequency coexistence confirmation module corresponds to the possibility of co-frequency interference, it is possible to further determine whether the co-frequency interference actually exists by comparing channel state information of communication paths.

In the case where history channel state information does not exist, it indicates that each communication path has signals for the first time. Channel state information corresponding to each communication path is unknown channel state information. If the channel state information is unknown, there is a conflict with the logic that a target digital logic level output by the co-frequency coexistence confirmation module corresponds to the possibility of co-frequency interference. It is impossible to further determine whether the co-frequency interference actually exists by comparing channel state information of communication paths. Therefore, the co-frequency coexistence confirmation module needs to send a channel estimation adjustment signal to the processing module. Thus, the processing module performs channel estimation again to obtain known channel state information.

Therefore, if the co-frequency coexistence confirmation module determines that the history channel state information exists before the first channel state information, step S6031 is executed. If the co-frequency coexistence confirmation module determines that the history channel state information does not exist before the first channel state information, step S6032 is executed.

In S6031, in the case where the history channel state information exists, the processing module uses the first channel state information as current channel state information and sends the current channel state information to the co-frequency coexistence confirmation module.

In S6032, in the case where the history channel state information does not exist, the co-frequency coexistence confirmation module sends a channel estimation adjustment signal to the processing module.

In S6041, the co-frequency coexistence confirmation module confirms channel states of every two of the at least two current operation channels according to the current channel state information.

In S6042, the processing module performs channel estimation on the current operation channel of a first communication path and the current operation channel of a second communication path to obtain second channel state information.

In S6051, in the case where channel states of every two of the at least two current operation channels satisfy a first channel state, the processing module executes a channel reallocation operation on the at least two current operation channels which are in one-to-one correspondence with the at least two communication paths to obtain at least two target operation channels which are in one-to-one correspondence with the at least two communication paths. Channel states of every two of the at least two target operation channels satisfy a second channel state.

In S6052, the processing module executes a reallocation operation on the current operation channel of the first communication path and the current operation channel of the second communication path based on the second channel state information to obtain a target operation channel corresponding to each communication path.

In some embodiments, the second channel state information is the channel state information of the current operation channel corresponding to the each of at least two communication paths when a signal is accessed for the first time. When performing channel allocation based on the second channel state information, the processing module may select, based on the channel state information of the current operation channel corresponding to each of at least two communication paths, a channel whose communication quality is greater than the communication quality corresponding to the channel state information obtained in the estimation step from preset channel intervals corresponding to the at least two communication paths. In a case where there is no channel whose communication quality is greater than the communication quality corresponding to the channel state information obtained in the estimation step, the original channel is kept unchanged.

In the case where at least two communication paths are the first communication path and the second communication path, the in-band channel of the first communication path is 1, 2, . . . . N, and the in-band channel of the second communication path is 0, 2, . . . . M. The channel allocation rule of the processing module can be as follows: selecting a channel with higher communication quality from channels 1˜└N/2┘ based on the channel state information of the first communication path, and selecting a channel with higher communication quality from channels ┌M−(M/2)┐˜M based on the channel state information of the second communication path.

After the execution of step S6051 or step S6052, the starting step of the method for controlling a wireless communication circuit is returned to continue to execute. The starting step in this embodiment is step S601.

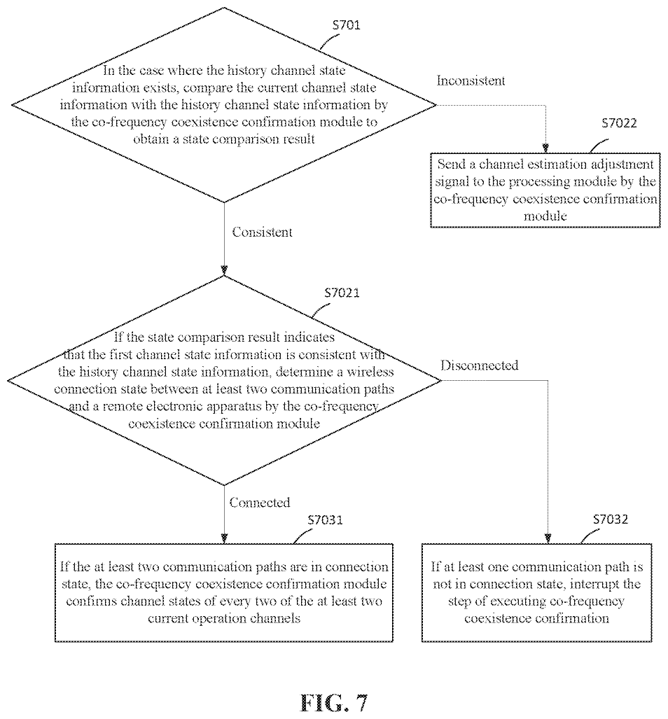

FIG. 7 is a flowchart of another method for controlling a wireless communication circuit according to an embodiment of the present application. Based on the embodiments in FIG. 6, as shown in FIG. 7, the co-frequency coexistence confirmation module confirms the channel states of every two of the at least two current operation channels according to the current channel state information including the following steps.

In S701, in the case where the history channel state information exists, the co-frequency coexistence confirmation module compares the current channel state information with the history channel state information to obtain a state comparison result.

If the state comparison result indicates that the current channel state information is consistent with the history channel state information, the current channel state information is not changed. If the state comparison result indicates that the current channel state information is inconsistent with the history channel state information, the co-frequency coexistence confirmation module sends a channel estimation adjustment signal to the processing module. Therefore, if the state comparison result indicates that the current channel state information is consistent with the history channel state information, S7021 is executed. If the state comparison result indicates that the current channel state information is inconsistent with the history channel state information, S7022 is executed.

In S7021, if the state comparison result indicates that the first channel state information is consistent with the history channel state information, the co-frequency coexistence confirmation module determines a wireless connection state between at least two communication paths and a remote electronic apparatus.

The wireless connection state between the at least two communication paths and the remote electronic apparatus includes a case where the at least two communication paths are in connection state and a case where at least one communication path is not in connection state. If the at least two communication paths are in connection state, it indicates that each communication path is in normal communication. In this case, step S7031 can be executed. After channel states of every two of the at least two current operation channels are determined, a channel reallocation operation is executed. If at least one communication path is not in connection state, it indicates that there is at least one of the at least two communication paths in which communication interruption occurs. Communication interruption may occur in one communication path, two communication paths, or all communication paths. In this case, step S7032 can be executed.

In S7022, the co-frequency coexistence confirmation module sends a channel estimation adjustment signal to the processing module.

In S7031, if the at least two communication paths are in connection state, the co-frequency coexistence confirmation module confirms channel states of every two of the at least two current operation channels.

In S7032, if at least one communication path is not in connection state, the step of executing co-frequency coexistence confirmation is interrupted.

In some embodiments, in the case where at least one communication path is not in connection state, it indicates that there is an open circuit in a communication path. In the case where there is an open circuit in the communication path, the condition that the co-frequency interference exists cannot be satisfied, resulting in an output digital logic level not being a target digital logic level. Therefore, the step of executing the co-frequency coexistence confirmation is interrupted.

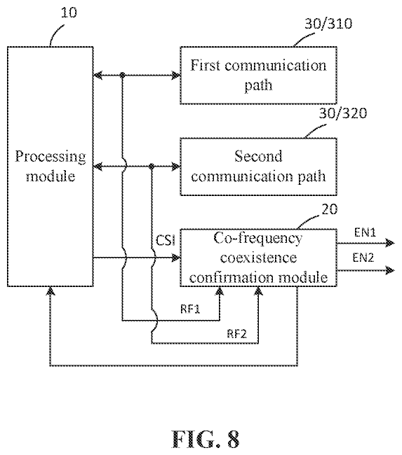

FIG. 8 is a diagram illustrating the structure of a wireless communication circuit according to an embodiment of the present application. The wireless communication circuit is configured to execute the method for controlling a wireless communication circuit provided in any of the preceding embodiments.

Referring to FIG. 8, a wireless communication circuit includes a processing module 10, a co-frequency coexistence confirmation module 20, and at least two communication paths 30. The at least two communication paths 30 transmit signals operating in the same frequency band and having different communication protocols.

The processing module 10 is electrically connected to the co-frequency coexistence confirmation module 20. The processing module 10 is electrically connected to each of the at least two communication path 30. The processing module 10 is configured to acquire current channel state information of at least two current operation channels which are in one-to-one correspondence with the at least two communication paths 30 and send the current channel state information to the co-frequency coexistence confirmation module 20.

The co-frequency coexistence confirmation module 20 is electrically connected to each of the at least two communication paths 30. The co-frequency coexistence confirmation module 20 is configured to confirm channel states of every two of the at least two current operation channels according to the current channel state information.

In the case where the channel states of every two of the at least two current operation channels satisfy a first channel state, the processing module is configured to execute a channel reallocation operation on at least two current operation channels to obtain at least two target operation channels which are in one-to-one correspondence with the at least two communication paths 30. Channel states of every two of the at least two target operation channels satisfy a second channel state. The first channel state is used for indicating that co-frequency interference exists between every two of the at least two current operation channels. The second channel state is used for indicating that there is no co-frequency interference between the at least two target operation channels.

In some embodiments, the at least two communication paths 30 include a first communication path 310 and a second communication path 320. The processing module 10 is electrically connected to the first communication path 310 and the second communication path 320. The processing module 10 transmits a first radio frequency signal RF1 to the first communication path 310 and transmits a second radio frequency signal RF2 to the second communication path 320.

The processing module 10 executes a channel reallocation operation on the at least two current operation channels of the at least two communication paths 30 to obtain at least two target operation channels. Then, the co-frequency coexistence confirmation module 20 sends a first enabling signal EN1 to the first communication path 310 and sends a second enabling signal EN2 to the second communication path 320 to enable the first communication path 310 and the second communication path 320. Thus, the first communication path 310 and the second communication path 320 operate on a respective corresponding target operation channel.

A current operation channel corresponding to a communication path in a connected state of at least two current operation channels is used as a first operation channel. A current operation channel corresponding to a communication path in an unconnected state of the at least two current operation channels is used as a second operation channel. The at least two target operation channels include a first target channel and a second target channel. The first operation channel corresponds to the first target channel. The second operation channel corresponds to the second target channel.

In some embodiments, in the case where channel states of every two of the at least two current operation channels satisfy the first channel state, the channel reallocation operation can be an operation of executing channel reallocation on both the first operation channel and the second operation channel. The processing module executes channel reallocation on both the first operation channel and the second operation channel to obtain the first target channel and the second target channel. Channel states of the first target channel and the second target channel satisfy the second channel state.

In some embodiments, in the case where channel states of every two of the at least two current operation channels satisfy the first channel state, the channel reallocation operation may be an operation of not executing channel reallocation on the first operation channel while executing channel reallocation on the second operation channel to obtain the second target channel. The channel states of the second target channel and the first operation channel satisfy the second channel state. In this case, the first target channel is the first operation channel. Exemplarily, the operation of performing channel reallocation on the second operation channel may be comparing channel state information of the current second operation channel with channel state information of other operation channels in the same interval, and selecting a channel with higher communication quality corresponding to the channel state information as the second target channel. The communication quality corresponds to the channel state information. That is, the communication quality is related to the channel gain, the signal attenuation, and the like. The communication quality is higher when the channel gain is larger. The communication quality is higher when the signal attenuation is smaller. The communication quality can be measured by collecting at least one piece of channel state information. That is, in this embodiment, the communication can be more stable without switching operation channels of connected communication paths.

With continued reference to FIG. 8, the specific operation of the wireless communication circuit provided in this embodiment of the present application is as follows.

The processing module 10 acquires current channel state information of current operation channels corresponding to the first communication path 310 and the second communication path 320 and sends the current channel state information to the co-frequency coexistence confirmation module 20. At the same time, the communication paths transmit a radio frequency signal to the co-frequency coexistence confirmation module 20. The co-frequency coexistence confirmation module 20 is enabled when the co-frequency coexistence confirmation module 20 confirms that both the first communication path 310 and the second communication path 320 have a target input signal (high level signal) input.

When the co-frequency coexistence confirmation module 20 is enabled, the co-frequency coexistence confirmation module 20 determines whether the current channel state information of the two communication paths is known. If the current channel state information of the two communication paths is unknown, it indicates that the two communication paths have signals for the first time, that is, the two communication paths have not received channel state information before. At this time, the co-frequency coexistence confirmation module 20 outputs a channel estimation adjustment signal. The processing module 10 first performs initial channel estimation. Then, the processing module 10 executes a channel reallocation operation on the current operation channel of each communication path based on the second channel state information.

If the current channel state information of the two communication paths is known, the co-frequency coexistence confirmation module 20 compares the current channel state information with history channel state information to obtain a state comparison result. If the state comparison result indicates that the current channel state information is consistent with the history channel state information, that is, the current channel state information does not change compared with the history channel state information, the co-frequency coexistence confirmation module 20 determines the wireless connection state between the at least two communication paths and a remote electronic apparatus. When the first communication path 310 and the second communication path 320 are in connection state, that is, in the case where channel states of every two of the at least two current operation channels satisfy the first channel state (including two cases: one is that the first communication path 310 is always in connection state and then the second communication path 320 is in connection state, and another is that the second communication path 320 is always connected in connection state and then the first communication path 310 is in connection state), the co-frequency coexistence confirmation module 20 sends a channel reallocation adjustment signal to execute a channel reallocation operation on the current operation channels of the communication paths 30.

If the state comparison result indicates that the current channel state information is inconsistent with the history channel state information, that is, the current channel state information is changed compared with the history channel state information (that is, the communication quality is changed), the co-frequency coexistence confirmation module 20 sends a channel estimation adjustment signal to the processing module 10. The processing module 10 performs channel estimation, selects a channel with higher communication quality according to the channel estimation result, and performs a channel reallocation operation for the current operation channel of each communication path.

After channel reallocation is executed on current operation channels of communication paths, the co-frequency coexistence confirmation module 20 can obtain current channel state information at this time. When the current channel state information has been changed to current channel state information corresponding to the allocated target operation channel, the co-frequency coexistence confirmation module 20 enables a communication path so that the communication path executes a communication operation on the target operation channel.

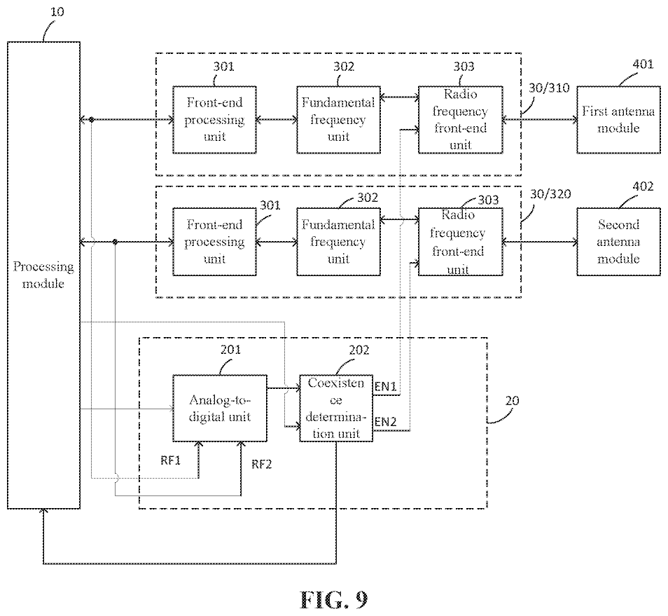

FIG. 9 is a diagram illustrating the structure of another wireless communication circuit according to an embodiment of the present application. Referring to FIG. 9, a co-frequency coexistence confirmation module 20 includes an analog-to-digital unit 201 and a coexistence determination unit 202. The analog-to-digital unit 201 is electrically connected to a processing module 10. The analog-to-digital unit 201 includes at least two signal input terminals and a coexistence determination enabling terminal. Signal input terminals are connected to communication paths 30 in a one-to-one manner. The coexistence determination enabling terminal is connected to the coexistence determination unit 202.

The analog-to-digital unit 201 is configured to have a target input signal at each signal input terminal and output a target digital logic level through the coexistence determination enabling terminal to enable the coexistence determination unit 202.

The coexistence determination unit 202 is configured to determine channel states of every two of the at least two current operation channels according to current channel state information in the enabling state.

The coexistence determination unit 202 includes an adjustment signal output terminal and a state information input terminal. The adjustment signal output terminal and the state information input terminal are electrically connected to the processing module 10.

The coexistence determination unit 202 is configured to acquire current channel state information from the processing module 10 through the state information input terminal and determine channel states of every two of the at least two current operation channels according to the current channel state information. In the case where the coexistence determination unit 202 receives the target digital logic level and the current channel state information, the step of co-frequency coexistence confirmation can be executed. That is, in the case where at least two communication paths are in connection state and the current channel state information is received, the step of co-frequency coexistence confirmation can be executed. In the case where at least one communication path is not in connection state, it indicates that there is an open circuit in the communication path. In the case where there is an open circuit in the communication path, the condition that the co-frequency interference exists cannot be satisfied, resulting in that the digital logic level output from the analog-to-digital unit 201 is not the target digital logic level, and the coexistence determination unit 202 cannot be enabled. Therefore, in the case where at least one communication path is not in connection state, the step of executing the co-frequency coexistence confirmation is interrupted.

In the case where channel states of every two of the at least two current operation channels satisfy a first channel state, the coexistence confirmation module 202 can send a channel reallocation adjustment signal to the processing module 10 through the adjustment signal output terminal.

The processing module 10 is configured to reallocate the at least two current operation channels of the at least two communication path 30 according to the channel reallocation adjustment signal to obtain at least two target operation channels which are in one-to-one correspondence with the at least two communication paths 30.

In some embodiments, each communication path 30 includes a front-end processing unit 301, a fundamental frequency unit 302, and a radio frequency front-end unit 303 that are sequentially connected from a first connection terminal to a second connection terminal. The radio frequency front-end unit 303 is configured to increase the frequency of a fundamental frequency signal or reduce the frequency of a signal received from the outside. The fundamental frequency unit 302 is configured to output a fundamental frequency signal to the front-end processing unit 301 or the radio frequency front-end unit 303. The front-end processing unit 301 is configured to process the received fundamental frequency signal and then output the processed fundamental frequency signal to the processing module 10, and/or to process digit information output from the processing module 10 and then output the processed digit information to the fundamental frequency unit. The enable output terminal of the coexistence determination unit 202 is connected to the radio frequency front-end unit 303. The coexistence determination unit 202 enables and controls the radio frequency front-end unit 303, thereby saving energy consumption of the wireless communication circuit.

The coexistence determination unit 202 also includes at least two communication path enabling terminals. Each of the at least two communication path enabling terminals is correspondingly connected to the input terminal of the radio frequency front-end unit 303 in each communication path.

After the processing module 10 executes a channel reallocation operation, the coexistence determination unit 202 is also configured to send enabling signals (that is, the coexistence determination unit 202 sends a first enabling signal EN1 to the first communication path 310 and sends a second enabling signal EN2 to the second communication path 320) through the communication path enabling terminals to enable every two of the at least two communication paths. Thus, the every two of the at least two communication paths operate on a respective corresponding target operation channel.

The wireless communication circuit also includes a first antenna module 401 and a second antenna module 402. The first antenna module 401 is connected to the second connection terminal of the first communication path 310. The second antenna module 402 is connected to the second connection terminal of the second communication path 320. The first antenna module 401 and the second antenna module 402 are configured to receive signals from corresponding communication paths 30 and transmit signals to the outside, or to receive signals from the outside and send signals to corresponding communication paths 30.

It is to be understood that various forms of the preceding flows may be used with steps reordered, added, or removed. For example, the steps described in the present application may be executed in parallel, in sequence, or in a different order as long as the desired results of the technical solutions in the present application are implemented. The execution sequence of these steps is not limited herein.

The scope of the present application is not limited to the preceding embodiments. It is to be understood by those skilled in the art that various modifications, combinations, subcombinations, and substitutions may be made according to design requirements and other factors. Any modifications, equivalent substitutions, improvements, and the like made within the spirit and principle of the present application fall within the scope of the present application.

What is claimed is:

1. A method for controlling a wireless communication circuit, comprising:
a processing module acquiring current channel state information of at least two current operation channels which are in one-to-one correspondence with at least two communication paths and sending the current channel state information to a co-frequency coexistence confirmation module, wherein the at least two communication paths transmit signals operating in a same frequency band and having different communication protocols;
the co-frequency coexistence confirmation module confirming channel states of every two of the at least two current operation channels according to the current channel state information; and
in response to the channel states of the every two of the at least two current operation channels satisfy a first channel state, the processing module performing a channel reallocation operation on the at least two current operation channels to obtain at least two target operation channels which are in one-to-one correspondence with the at least two communication paths, wherein channel states of every two of the at least two target operation channels satisfy a second channel state,
wherein the first channel state is used for indicating that co-frequency interference exists between the every two of the at least two current operation channels; and the second channel state is used for indicating that there is no co-frequency interference between every two of the at least two target operation channels.

2. The control method according to claim 1, wherein the at least two communication paths comprise a first communication path and a second communication path, wherein a first channel allocation range corresponding to the first communication path comprises a first channel interval and a second channel interval, and a second channel allocation range corresponding to the second communication path comprises a third channel interval and a fourth channel interval; and the first channel interval does not overlap with the fourth channel interval, and the second channel interval does not overlap with the third channel interval; and
wherein, in the case where the channel states of the every two of the at least two current operation channels satisfy the first channel state, the processing module performs the channel reallocation operation on the at least two current operation channels to obtain the at least two target operation channels which are in one-to-one correspondence with the at least two communication paths, comprises:
in a case where the first communication path maintains communication and a current operation channel corresponding to the first communication path belongs to the first channel interval, the processing module allocating any channel in the first channel interval as a target channel corresponding to the first communication path and allocating any channel in the fourth channel interval as a target operation channel of the second communication path; and
in a case where the first communication path maintains communication and a current operation channel corresponding to the first communication path belongs to the second channel interval, the processing module allocating any channel in the second channel interval as a target channel corresponding to the first communication path and allocating any channel in the third channel interval as a target operation channel of the second communication path.

3. The control method according to claim 1, wherein the at least two communication paths comprise a first communication path and a second communication path, wherein a first channel allocation range corresponding to the first communication path comprises a first channel interval and a second channel interval, and a second channel allocation range corresponding to the second communication path comprises a third channel interval and a fourth channel interval; and the first channel interval does not overlap with the fourth channel interval, and the second channel interval does not overlap with the third channel interval; and
in a case where the channel states of the any two of at least two current operation channels satisfy the first channel state, the processing module performs the channel reallocation operation on the at least two current operation channels to obtain the at least two target operation channels which are in one-to-one correspondence with the at least two communication paths, comprises:
in a case where the second communication path maintains communication and a current operation channel corresponding to the second communication path belongs to the third channel interval, the processing module allocating any channel in the third channel interval as a target channel corresponding to the second communication path and allocating any channel in the second channel interval as a target operation channel of the first communication path; and
in a case where the second communication path maintains communication and a current operation channel corresponding to the second communication path belongs to the fourth channel interval, the processing module allocating any channel in the fourth channel interval as a target channel corresponding to the second communication path and allocating any channel in the first channel interval as a target operation channel of the first communication path.

4. The control method according to claim 1, wherein the co-frequency coexistence confirmation module comprises an analog-to-digital unit and a coexistence determination unit, and before the processing module acquires the current channel state information of the at least two current operation channels which are in one-to-one correspondence with the at least two communication paths, the method further comprises:
the analog-to-digital unit detecting whether the at least two communication paths have target input signals at the same time; and
in response to the at least two communication paths have the target input signals at the same time, the analog-to-digital unit outputting a target digital logic level to enable the coexistence determination unit; and
wherein the processing module acquires the current channel state information of the at least two current operation channels which are in one-to-one correspondence with the at least two communication paths, comprises:
in response to enabling the coexistence determination unit, the processing module acquiring the current channel state information of the at least two current operation channels which are in one-to-one correspondence with the at least two communication paths.

5. The control method according to claim 1, wherein the co-frequency coexistence confirmation module comprises a coexistence determination unit, and after, in response to the channel states of the every two of the at least two current operation channels satisfy the first channel state, the processing module performs the channel reallocation operation on the at least two current operation channels to obtain the at least two target operation channels which are in one-to-one correspondence with the at least two communication paths, the method further comprises:
the coexistence determination unit enables the at least two communication paths so that every two of the at least two communication paths operate on a respective corresponding target operation channel.

6. The control method according to claim 1, wherein the processing module acquires the current channel state information of the at least two current operation channels which are in one-to-one correspondence with the at least two communication paths, comprises:
the processing module performing channel estimation on the at least two current operation channels which are in one-to-one correspondence with the at least two communication paths to obtain first channel state information corresponding to each of the at least two communication paths;
the co-frequency coexistence confirmation module determining whether history channel state information exists before the first channel state information; and
in a case where the history channel state information exists, the processing module using the first channel state information as the current channel state information.

7. The control method according to claim 6, wherein after the co-frequency coexistence confirmation module determines whether the history channel state information exists before the current channel state information, the method further comprises:
in a case where there is no history channel state information, the co-frequency coexistence confirmation module sending a channel estimation adjustment signal to the processing module;
the processing module performing channel estimation on the at least two current operation channels to obtain second channel state information corresponding to each of the at least two communication paths, wherein the second channel state information is used for triggering the processing module to reallocate the at least two current operation channels; and
the processing module using the second channel state information as the current channel state information.

8. The control method according to claim 6, wherein the co-frequency coexistence confirmation module confirming the channel states of the every two of the at least two current operation channels according to the current channel state information comprises:
in a case where the history channel state information exists, the co-frequency coexistence confirmation module comparing the current channel state information with the history channel state information to obtain a state comparison result;
in response to the state comparison result indicates that the first channel state information is consistent with the history channel state information, the co-frequency coexistence confirmation module determining a wireless connection state between the at least two communication paths and a remote electronic apparatus; and
in response to the at least two communication paths are in connection state, the co-frequency coexistence confirmation module confirming the channel states of the every two of the at least two current operation channels according to the first channel state information.

9. The control method according to claim 1, wherein, in response to the channel states of the every two of the at least two current operation channels satisfy the first channel state, the processing module performs the channel reallocation operation on the at least two current operation channels to obtain the at least two target operation channels which are in one-to-one correspondence with the at least two communication paths, comprises:
in response to the channel states of the every two of the at least two current operation channels satisfy the first channel state, the co-frequency coexistence confirmation module sending a channel reallocation adjustment signal to the processing module; and
the processing module performing, according to the channel reallocation adjustment signal, the channel reallocation operation on the at least two current operation channels which are in one-to-one correspondence with the at least two communication paths to obtain the at least two target operation channels.

10. The control method according to claim 2, wherein, in response to the channel states of the every two of the at least two current operation channels satisfy the first channel state, the processing module performs the channel reallocation operation on the at least two current operation channels to obtain the at least two target operation channels which are in one-to-one correspondence with the at least two communication paths, comprises:
in response to the channel states of the every two of the at least two current operation channels satisfy the first channel state, the co-frequency coexistence confirmation module sending a channel reallocation adjustment signal to the processing module; and
the processing module performing, according to the channel reallocation adjustment signal, the channel reallocation operation on the at least two current operation channels which are in one-to-one correspondence with the at least two communication paths to obtain the at least two target operation channels.

11. The control method according to claim 3, wherein, in response to the channel states of the every two of the at least two current operation channels satisfy the first channel state, the processing module performs the channel reallocation operation on the at least two current operation channels to obtain the at least two target operation channels which are in one-to-one correspondence with the at least two communication paths, comprises:
in response to the channel states of the every two of the at least two current operation channels satisfy the first channel state, the co-frequency coexistence confirmation module sending a channel reallocation adjustment signal to the processing module; and
the processing module performing, according to the channel reallocation adjustment signal, the channel reallocation operation on the at least two current operation channels which are in one-to-one correspondence with the at least two communication paths to obtain the at least two target operation channels.

12. A wireless communication circuit configured to execute the method for controlling a wireless communication circuit according to claim 1, wherein the wireless communication circuit comprises a processing module, a co-frequency coexistence confirmation module, and at least two communication paths, wherein the at least two communication paths transmit signals operating in a same frequency band and having different communication protocols;
the processing module is electrically connected to the co-frequency coexistence confirmation module, the processing module is separately and electrically connected to each of the at least two communication paths, and the processing module is configured to acquire current channel state information of at least two current operation channels which are in one-to-one correspondence with the at least two communication paths and send the current channel state information to the co-frequency coexistence confirmation module;
the co-frequency coexistence confirmation module is separately and electrically connected to each of the at least two communication paths, and the co-frequency coexistence confirmation module is configured to confirm channel states of every two of the at least two current operation channels according to the current channel state information; and
in response to the channel states of every two of at least two current operation channels satisfy a first channel state, the processing module is configured to perform channel reallocation operation on the at least two current operation channels to obtain at least two target operation channels which are in one-to-one correspondence with the at least two communication paths, and channel states of the every two of the at least two target operation channels satisfy a second channel state, wherein the first channel state is used for indicating that co-frequency interference exists between the every two of the at least two current operation channels, and the second channel state is used for indicating that there is no co-frequency interference between the at least two target operation channels.

13. The wireless communication circuit according to claim 12, wherein the at least two communication paths comprise a first communication path and a second communication path, wherein a first channel allocation range corresponding to the first communication path comprises a first channel interval and a second channel interval, and a second channel allocation range corresponding to the second communication path comprises a third channel interval and a fourth channel interval; and the first channel interval does not overlap with the fourth channel interval, and the second channel interval does not overlap with the third channel interval; and
in a case where the first communication path maintains communication and a current operation channel corresponding to the first communication path belongs to the first channel interval, the processing module is configured to allocate any channel in the first channel interval as a target channel corresponding to the first communication path and allocate any channel in the fourth channel interval as a target operation channel of the second communication path; and
in a case where the first communication path maintains communication and a current operation channel corresponding to the first communication path belongs to the second channel interval, the processing module is configured to allocate any channel in the second channel interval as a target channel corresponding to the first communication path and allocate any channel in the third channel interval as a target operation channel of the second communication path.

14. The wireless communication circuit according to claim 12, wherein the at least two communication paths comprise a first communication path and a second communication path, wherein a first channel allocation range corresponding to the first communication path comprises a first channel interval and a second channel interval, and a second channel allocation range corresponding to the second communication path comprises a third channel interval and a fourth channel interval; and the first channel interval does not overlap with the fourth channel interval, and the second channel interval does not overlap with the third channel interval; and
in a case where the second communication path maintains communication and a current operation channel corresponding to the second communication path belongs to the third channel interval, the processing module is configured to allocate any channel in the third channel interval as a target channel corresponding to the second communication path and allocate any channel in the second channel interval as a target operation channel of the first communication path; and
in a case where the second communication path maintains communication and a current operation channel corresponding to the second communication path belongs to the fourth channel interval, the processing module is configured to allocate any channel in the fourth channel interval as a target channel corresponding to the second communication path and allocate any channel in the first channel interval as a target operation channel of the first communication path.

15. The wireless communication circuit according to claim 12, wherein the co-frequency coexistence confirmation module comprises an analog-to-digital unit and a coexistence determination unit;
before the processing module acquires the current channel state information of the at least two current operation channels which are in one-to-one correspondence with the at least two communication paths, the analog-to-digital unit is configured to detect whether the at least two communication paths have target input signals at the same time, and in response to the at least two communication paths have the target input signals at the same time, the analog-to-digital unit is configured to output a target digital logic level to enable the coexistence determination unit; and
in response to enabling the coexistence determination unit, the processing module is configured to acquire the current channel state information of the at least two current operation channels which are in one-to-one correspondence with the at least two communication paths.

16. The wireless communication circuit according to claim 12, wherein the co-frequency coexistence confirmation module comprises a coexistence determination unit, and
the coexistence determination unit is configured to enable the at least two communication paths so that every two of the at least two communication paths operate on a respective corresponding target operation channel, after, in response to the channel states of the every two of the at least two current operation channels satisfy the first channel state, the processing module performs the channel reallocation operation on the at least two current operation channels to obtain the at least two target operation channels which are in one-to-one correspondence with the at least two communication paths.

17. The wireless communication circuit according to claim 12, wherein the processing module is configured to perform channel estimation on the at least two current operation channels which are in one-to-one correspondence with the at least two communication paths to obtain first channel state information corresponding to each of the at least two communication paths;
the co-frequency coexistence confirmation module is configured to determine whether history channel state information exists before the first channel state information; and
in a case where the history channel state information exists, the processing module is configured to use the first channel state information as the current channel state information.

18. The wireless communication circuit according to claim 17, wherein
in a case where there is no history channel state information, the co-frequency coexistence confirmation module is configured to send a channel estimation adjustment signal to the processing module after the co-frequency coexistence confirmation module determines whether the history channel state information exists before the current channel state information;
the processing module is configured to perform channel estimation on the at least two current operation channels to obtain second channel state information corresponding to each of the at least two communication paths, wherein the second channel state information is used for triggering the processing module to reallocate the at least two current operation channels; and
the processing module is configured to use the second channel state information as the current channel state information.

19. The wireless communication circuit according to claim 17, wherein
in a case where the history channel state information exists, the co-frequency coexistence confirmation module is configured to compare the current channel state information with the history channel state information to obtain a state comparison result;
in response to the state comparison result indicates that the first channel state information is consistent with the history channel state information, the co-frequency coexistence confirmation module is configured to determine a wireless connection state between the at least two communication paths and a remote electronic apparatus; and
in response to the at least two communication paths are in connection state, the co-frequency coexistence confirmation module is configured to confirm the channel states of the every two of the at least two current operation channels according to the first channel state information.

20. The wireless communication circuit according to claim 12, wherein
in response to the channel states of the every two of the at least two current operation channels satisfy the first channel state, the co-frequency coexistence confirmation module is configured to send a channel reallocation adjustment signal to the processing module; and
the processing module is configured to perform, according to the channel reallocation adjustment signal, the channel reallocation operation on the at least two current operation channels which are in one-to-one correspondence with the at least two communication paths to obtain the at least two target operation channels.
